(19) United States
(12) Patent Application Publication
(10) Pub. No.: US 2021/0089379 A1
(43) Pub. Date: Mar. 25, 2021

(54) COMPUTER SYSTEM

(71) Applicant: HITACHI, LTD., Tokyo (JP)

(72) Inventor: Ryo AIKAWA, Tokyo (JP)

(73) Assignee: HITACHI, LTD., Tokyo (JP)

(21) Appl. No.: 16/818,129

(22) Filed: Mar. 13, 2020

(30) Foreign Application Priority Data
Sep. 25, 2019 (JP) 2019-173820

(51) Int. Cl. G06F 11/07; G06F 11/16; G06F 11/30

(52) U.S. Cl. CPC G06F 11/0709; G06F 11/0712; G06F 11/3006; G06F 11/1658; G06F 11/0772

(57) ABSTRACT

A computer system includes a cluster. The cluster includes nodes, which are allowed to hold communication to and from one another over a network, and which are configured to store user data from at least one calculation node. The nodes include old master nodes. The nodes each includes reference information, which indicates master nodes of the cluster. The computer system is configured to add, when a failure occurs in a master node that is one of the old master nodes, new master nodes to the cluster in a number equal to or larger than a minimum unit number of master nodes, which is determined in advance in order to manage the cluster. Each old master node that is in operation out of the old master nodes is configured to rewrite the reference information held in each old master node so that the new master nodes are indicated.

### CLAIM OF PRIORITY

The present application claims priority from Japanese patent application JP2019-173820 filed on Sep. 25, 2019, the content of which is hereby incorporated by reference into this application.

### BACKGROUND

This disclosure relates to a computer system. The background art of this disclosure includes U.S. Pat. No. 9,690,675 B2. In U.S. Pat. No. 9,690,675 B2, there are disclosed, for example, “Systems, methods, and computer program products for managing a consensus group in a distributed computing cluster by determining that an instance of an authority module executing on a first node, of a consensus group of nodes in the distributed computing cluster, has failed; and adding, by an instance of the authority module on a second node of the consensus group, a new node to the consensus group to replace the first node. The new node is a node in the computing cluster that was not a member of the consensus group at the time when the instance of the authority module executing on the first node is determined to have failed.” (see Abstract, for example).

### SUMMARY

In a cluster including a plurality of storage nodes and further including a plurality of master nodes, a failure in the master nodes diminishes or obliterates the redundancy of the master nodes. Dynamic addition of a master node without shutting down the system (cluster) depends greatly on whether a coordination service/scale-out database installed in the master node can dynamically be added. When the coordination service/scale-out database cannot dynamically be added, the system requires to be shut down and rebooted, which significantly impairs the availability of the cluster.

A technology capable of restoring the redundancy of the master nodes without impairing the availability of the system even when the coordination service/scale-out database is not fit for dynamic addition is therefore demanded.

An aspect of this invention is a computer system including a cluster. The cluster includes a plurality of nodes, which are allowed to hold communication to and from one another over a network, and which are configured to store user data from at least one calculation node. The plurality of nodes include a plurality of old master nodes. The plurality of nodes each includes reference information, which indicates master nodes of the cluster. The computer system is configured to add, when a failure occurs in a master node that is one of the plurality of old master nodes, new master nodes to the cluster in a number equal to or larger than a minimum unit number of master nodes, which is determined in advance in order to manage the cluster. Each old master node that is in operation out of the plurality of old master nodes is configured to rewrite the reference information held in each old master node so that the new master nodes are indicated.

According to at least one aspect of this invention, the redundancy of the master nodes can be restored without impairing the availability of the system.

### BRIEF DESCRIPTION OF THE DRAWINGS

FIG. 1 is a block diagram for schematically illustrating a configuration of a computer system according to a first embodiment of this invention;

FIG. 2 is an illustration of a hardware configuration example of the master node;

FIG. 3 is a table for showing an example of a structure of a configuration information file;

FIG. 4 is a table for showing an example of a structure of a coordination service settings file;

FIG. 5 is a table for showing an example of a structure of a scale-out database settings file;

FIG. 6 is a flow chart of processing to be executed when a failure occurs in one of the master nodes of the cluster;

FIG. 7A and FIG. 7B are sequence diagrams for illustrating details of the processing of FIG. 6;

FIG. 8 is an illustration of the coordination service settings file and the scale-out database settings file in each old master node prior to the occurrence of a failure;

FIG. 9 is an illustration of the reference destination information of the configuration information file in the worker node prior to the occurrence of a failure;

FIG. 10 is an illustration of the coordination service settings file and the scale-out database settings file in each new master node;

FIG. 11 is an illustration of the changed reference destination information in the configuration information file of the worker node;

FIG. 12 is a flow chart for illustrating processing to be executed when a failure occurs in one of the master nodes of the cluster;

FIG. 13A and FIG. 13B are sequence diagrams for illustrating details of the processing of FIG. 12;

FIG. 14 is an illustration of the coordination service settings file and the scale-out database settings file in each new master node;

FIG. 15 is an illustration of the changed reference destination information in the configuration information file of the worker node;

FIG. 16 is an illustration of the changed coordination service settings file and scale-out database settings file in the old master nodes;

FIG. 17 is an illustration of the reference destination information in the configuration information file of the worker node that has been changed after the joining of the old master nodes; and

FIG. 18A and FIG. 18B are sequence diagrams for illustrating processing to be executed when a failure occurs in one of secondary master nodes of the cluster.

### DETAILED DESCRIPTION OF EMBODIMENTS

Embodiments of this disclosure are described below with reference to the accompanying drawings. In the following description, a computer system is a system including one or more physical computers. The physical computers may be general computers or dedicated computers. The physical computers may function as computers configured to issue an input/output (I/O) request, or computers configured to execute data I/O in response to an I/O request.

In other words, the computer system may be at least one of a system including one or more computers configured to issue an I/O request and a system including one or more computers configured to execute data I/O in response to an I/O request. On at least one physical computer, one or more virtual computers may be run. The virtual computers may be computers configured to issue an I/O request, or computers configured to execute data I/O in response to an I/O request.

In the following description, some sentences describing processing have “program” as the subject. However, the sentences describing processing may have “processor” (or a controller or similar device that includes a processor) as the subject because a program is executed by a processor to perform prescribed processing while suitably using, for example, a storage unit and/or an interface unit.

A program may be installed in a computer or a similar apparatus from a program source. The program source may be, for example, a program distribution server or a computer-readable (for example, non-transitory) recording medium. In the following description, two or more programs may be implemented as one program, and one program may be implemented as two or more programs.

The following description may use “xxx file” or a similar expression to describe information from which output is obtained in response to input. The information, however, may be data having any structure. Each file configuration in the following description is an example, and one file may be divided into two or more files, while all or some of two or more files may be configured as one file.

### First Embodiment

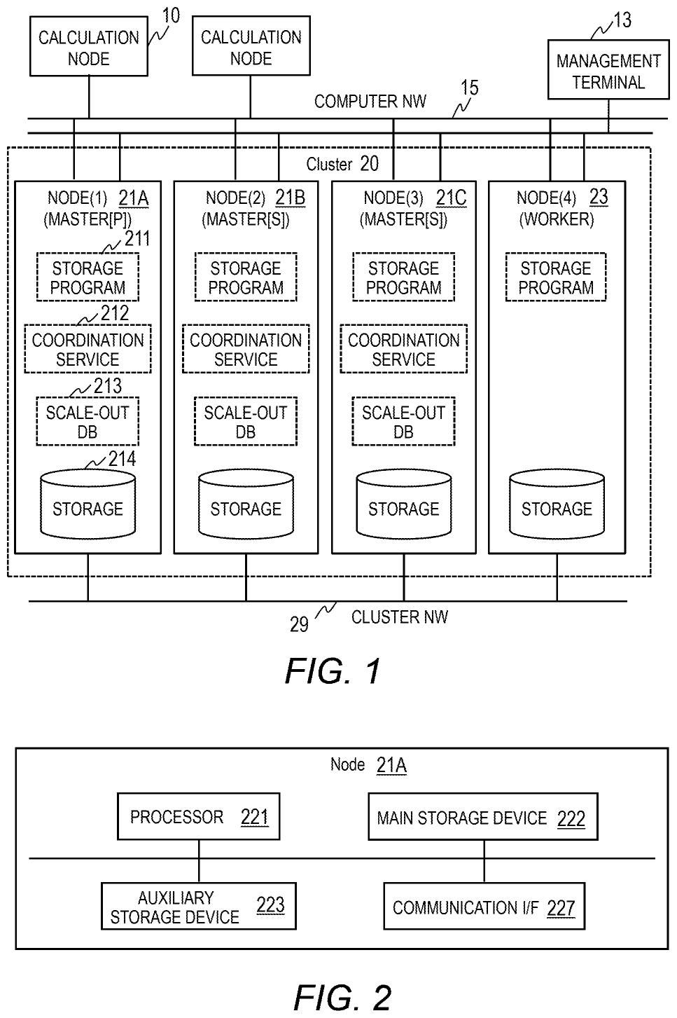

FIG. 1 is a block diagram for schematically illustrating a configuration of a computer system according to a first embodiment of this invention. The computer system includes one or more calculation nodes (host nodes) 10, a management terminal 13, and a cluster 20. Two calculation nodes 10 are illustrated in FIG. 1 as an example, and one of the two is indicated by the reference symbol 10 as an example. The calculation nodes 10, the management terminal 13, and the cluster 20 can hold communication to and from one another over a calculation network (NW) 15.

The cluster 20 is a distributed storage system including a plurality of storage nodes, and receives I/O from the calculation nodes 10. The cluster 20 stores write data received from the calculation nodes 10 as requested by write requests from the calculation nodes 10. The cluster 20 reads, out of stored data, specified data as requested by read requests from the calculation nodes 10 and returns the read data to the calculation nodes 10. The management terminal 13 is used by an administrator (a user) to manage the computer system.

The cluster 20 includes a plurality of master nodes, or includes a plurality of master nodes and one or more worker nodes. The worker nodes may not be included in the cluster 20. In the configuration example illustrated in FIG. 1, the cluster 20 includes three master nodes (a node (1) 21A, a node (2) 21B, and a node (3) 21C) and one worker node (a node (4) 23). The nodes in the cluster 20 are physical nodes or virtual nodes.

The master nodes 21A, 21B, and 21C and the worker node 23 can hold communication to and from one another over a cluster network 29. The calculation network 15 and the cluster network 29 may be configured as one network.

The nodes in the cluster 20 are storage nodes (storage apparatus), which store user data received from the calculation nodes 10, and return specified user data to the calculation nodes 10. The nodes each include a storage program 211 and a storage 214. In FIG. 1, the storage program and the storage in the master node 21A are indicated by reference symbols 211 and 214, respectively, as an example. The storage 214 stores user data from the calculation nodes 10. The storage program 211 executes I/O processing in response to requests from the calculation nodes 10.

In addition to receiving I/O from the calculation nodes 10, the master nodes 21A, 21B, and 21C execute management and control of the cluster 20, which are not executed by the worker node 23. One of the master nodes 21A, 21B, and 21C is selected as a primary master node. The rest of the master nodes are secondary master nodes. In the configuration example of FIG. 1, the master node 21A is the primary master node and the other master nodes 21B and 21C are the secondary master nodes.

The primary master node 21A performs overall management of the cluster 20. The primary master node 21A gives an instruction on a configuration change in the cluster 20, for example, a change in volume configuration or node configuration of the cluster 20, to the other nodes. For instance, when a failure occurs in one of the nodes in the cluster 20, the primary master node 21A instructs the other nodes to execute required processing.

The secondary master nodes 21B and 21C are nodes that are candidates for a primary master node. When a failure occurs in the primary master node 21A, any one of the secondary master nodes 21B and 21C is selected as a primary master node. The presence of a plurality of master nodes ensures redundancy for a failure in the primary master node.

Each master node includes a coordination service 212 and a scale-out database (DB) 213. The coordination service 212 is a program. In FIG. 1, the coordination service and the scale-out database in the master node 21A are indicated by reference symbols 212 and 213, respectively, as an example.

The coordination service 212 executes processing involving one master node and at least one other master node. For example, the coordination service 212 executes processing of selecting a primary master node from master nodes, and also executes communication for synchronizing management information among the master nodes. The coordination service 212 of each master node holds communication to and from the coordination services of the other master nodes so that there is always a primary master node. The management information includes information held by the coordination service 212 and information stored in the scale-out database 213.

The scale-out database 213 stores configuration information and control information on the cluster 20. The scale-out database 213 stores, for example, information on the configuration (hardware configuration and software configuration) and address of each node in the cluster 20, and information on volumes managed in the cluster 20.

The scale-out database 213 also stores information about the states of nodes in the cluster 20, for example, the roles of the respective nodes, which node is the primary master node, and a node in which a failure has occurred. The scale-out database 213 includes information already stored at the time of booting of the system, and information updated in the system.

The scale-out database 213 is updated by the storage program 211. The content of the scale-out database 213 is synchronized among the master nodes (the content is kept identical in every master node) by the coordination service 212. The scale-out database 213 may have the function of executing content synchronization processing. Information of a management table described later is obtained from the scale-out database 213.

FIG. 2 is an illustration of a hardware configuration example of the master node 21A. The other nodes in the cluster 20 may have the same configuration as the example. The master node 21A may have a computer configuration. The master node 21A includes a processor 221, a main storage device 222, an auxiliary storage device 223, and a communication interface (I/F) 227. The components are coupled to one another by a bus.

The main storage device 222, the auxiliary storage device 223, or a combination thereof is a storage device including a non-transitory storage medium, and stores a program and data that are used by the processor 221. The auxiliary storage device 223 provides a storage area of the storage 214, which stores user data of the calculation nodes 10.

The main storage device 222 includes, for example, a semiconductor memory, and is used mainly to hold a program being run and data being used. The processor 221 executes various types of processing as programmed by programs stored in the main storage device 222. The processor 221 implements various function modules by operating as programmed by programs. The auxiliary storage device 223 includes, for example, one or a plurality of hard disk drives, solid-state drives, or other large-capacity storage devices, and is used to keep a program and data for a long period of time.

The processor 221 may be a single processing unit or a plurality of processing units, and may include a single or a plurality of arithmetic units, or a plurality of processing cores. The processor 221 may be implemented as one or a plurality of central processing units, microprocessors, microcomputers, microcontrollers, digital signal processors, state machines, logic circuits, graphic processing apparatus, systems-on-a-chip, and/or freely-selected apparatus that manipulate a signal as instructed by a control instruction.

A program and data that are stored in the auxiliary storage device 223 are loaded, in booting or when required, onto the main storage device 222, and the processor 221 executes the loaded program, to thereby execute various types of processing of the master node 21A. Processing executed below by the master node 21A is accordingly processing by the processor 221 or by the program. The communication I/F 227 is an interface for coupling to a network.

The calculation nodes 10 and the management terminal 13 may have the computer configuration illustrated in FIG. 2. The management terminal 13 may further include an input device and an output device. The input device is a hardware device through which a user inputs an instruction, information, and the like to the management terminal 13. The output device is a hardware device on which various images for input/output are presented, for example, a display device or a printing device. The input device and the output device may be installed in the calculation nodes 10 and the nodes in the cluster 20.

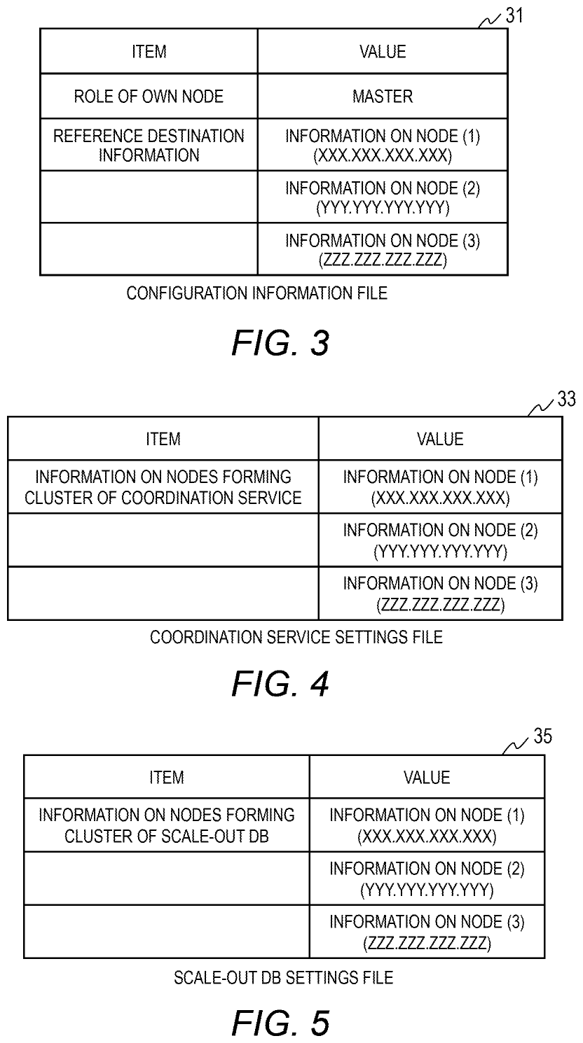

An example of the management table held by each node of the computer system is described below. FIG. 3 is a table for showing an example of a structure of a configuration information file 31. Each node in the cluster 20 holds the configuration information file 31. The configuration information file 31 in each node stores the role of its own node, and information (for example, an IP address) for identifying each master node in order to access the master node. The role of the own node indicates whether the own node is a master node or a worker node. The example illustrated in FIG. 3 is the configuration information file 31 of a master node.

FIG. 4 is a table for showing an example of a structure of a coordination service settings file 33. Each master node in the cluster 20 holds the coordination service settings file 33. The coordination service settings file 33 stores information (for example, IP addresses) for identifying nodes that form a cluster of the coordination service, namely, the master nodes in the cluster 20, so that each of the master nodes can be accessed.

FIG. 5 is a table for showing an example of a structure of a scale-out database settings file 35. Each master node in the cluster 20 holds the scale-out database settings file 35. The scale-out database settings file 35 stores information (for example, IP addresses) for identifying nodes that form a cluster of the scale-out database, namely, the master nodes in the cluster 20, so that each of the master nodes can be accessed.

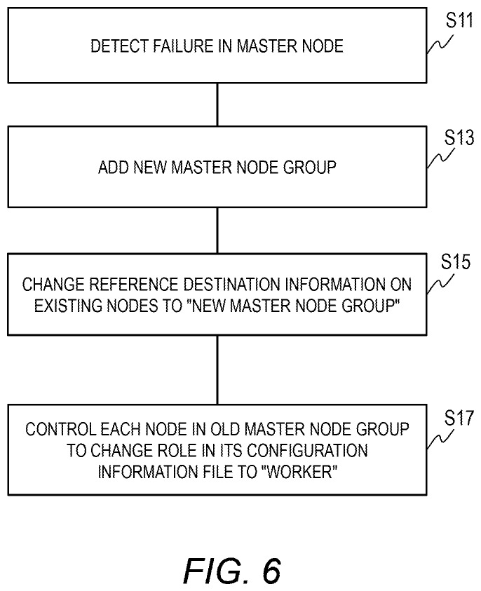

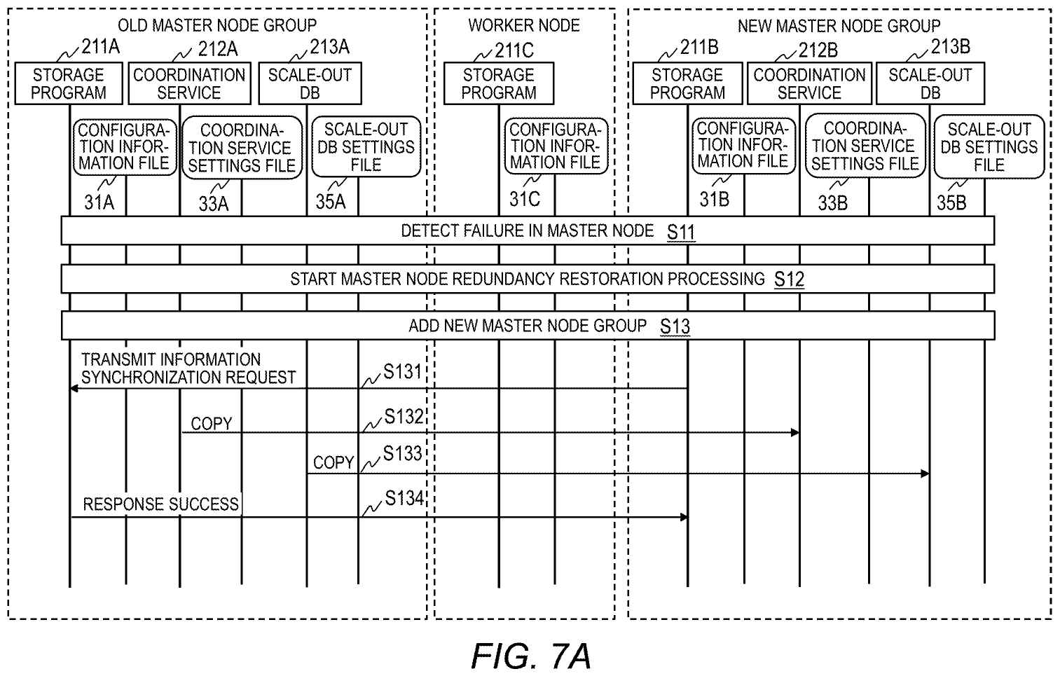

Next, referring to a flow chart of FIG. 6, processing to be executed when a failure occurs in one of the master nodes of the cluster 20 is described. In the configuration example illustrated in FIG. 1, the minimum unit of a master node group is three master nodes, specifically, one primary master node and two secondary master nodes. The minimum unit is determined in advance in system design, and indicates the minimum number of master nodes that have redundancy required to manage a cluster. A failure in any one of the master nodes therefore means that required redundancy is not secured.

In the first embodiment, the cluster 20 requires to be shut down in order to add a master node to existing master nodes. For instance, the addition of a master node to existing master nodes requires the coordination service 212 and the scale-out database 213 to restart in the master nodes.

When a failure occurs in a master node, as many new master nodes as the minimum unit number of master nodes or more are added to the cluster 20 in the first embodiment. Specifically, when the number of master nodes that is the minimum unit is three, three or more master nodes are added to the cluster 20. In this manner, the management (master authority) of the cluster 20 can be transferred from the old master node group to the newly added master node group (new master node group) without shutting down the cluster 20. Required redundancy can thus be restored (including expansion) without impairing the availability of the cluster 20. The number of master nodes that is the minimum unit depends on design.

In an example described below, the number of new master nodes is three, and matches the number of master nodes that is the minimum unit. This accomplishes efficient cluster management. Master node redundancy can be returned to the level of redundancy immediately before the failure by adding the same number of new master nodes as the number of old master nodes immediately before the failure. The post-failure master group in the example described below includes the added new master nodes alone, and none of the old master nodes. This accomplishes efficient cluster management while restoring master node redundancy.

In the example described below, a new master node group is added when a failure occurs in one of the minimum unit number of master nodes. Processing of adding a new master node group can thus be avoided as much as possible while maintaining required master node redundancy. As a different method, a new master node group may be added when the number of master nodes after a master node failure is equal to or larger than the minimum unit.

Reference is made to FIG. 6. When a failure occurs in any one of the master nodes in the cluster 20 (Step S11), a new master node group including three or more master nodes is added to the cluster 20 (Step S13). For example, the system administrator adds to the cluster 20 a new master node group to which required settings are set. The new master nodes are physical master nodes or virtual master nodes.

Each of the added new master nodes holds, in advance, information on the respective new master nodes, and can hold communication to and from the other new master nodes. One primary master node is selected from the added new master node group. The new master node group is capable of communication to and from old master nodes in the cluster 20, and obtains information held in the coordination service 212 and in the scale-out database 213 from the old master node group.

Next, each existing node changes reference destination information of the configuration information file 31 to information on the new master node group (Step S15). Each old master node in the old master node group that is in operation further changes its own role in the configuration information file 31 from “master” to “worker” (Step S17). Each old master node stops the coordination service 212 and the scale-out database 213. Dynamic addition of a new master node group (redundancy restoration) is completed in the manner described above.

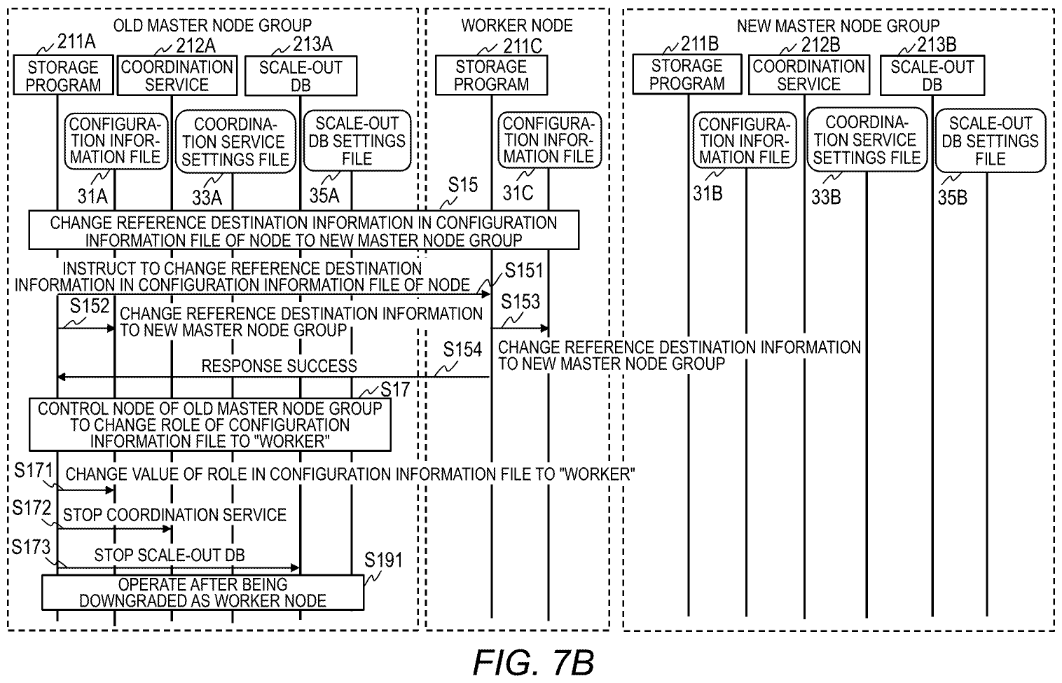

FIG. 7A and FIG. 7B are sequence diagrams for illustrating details of the processing of FIG. 6. Processing illustrated in FIG. 7A is followed by processing illustrated in FIG. 7B. In FIG. 7A and FIG. 7B, each old master node that is in operation includes a storage program 211A, a coordination service 212A, a scale-out database 213A, a configuration information file 31A, a coordination service settings file 33A, and a scale-out database settings file 35A. The worker node 23 includes a storage program 211C and a configuration information file 31C.

Each new master node includes a storage program 211B, a coordination service 212B, a scale-out database 213B, a configuration information file 31B, a coordination service settings file 33B, and a scale-out database settings file 35B. In an example described below, the new master node group includes three master nodes, which are the minimum unit. Required redundancy is efficiently accomplished in this manner.

Reference is made to FIG. 7A. When a failure occurs in any one of the master nodes in the cluster 20 (Step S11), master node redundancy restoration processing is started (Step S12). The new master node group is added to the cluster 20 (Step S13). The scale-out database 213B holds information on the new master node group, and the information is reflected in the files 31B, 33B, and 35B. The scale-out database 213B holds address information on the old master nodes.

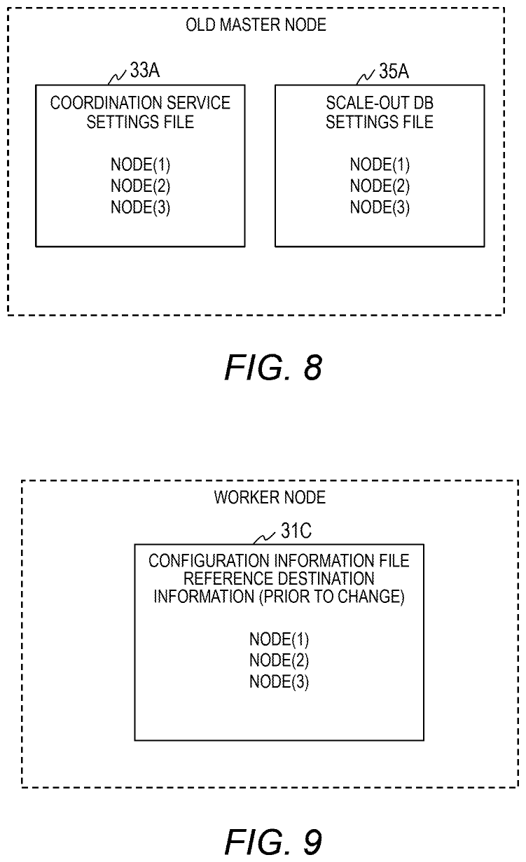

FIG. 8 is an illustration of the coordination service settings file 33A and the scale-out database settings file 35A in each old master node prior to the occurrence of a failure. The coordination service settings file 33A and the scale-out database settings file 35A each indicate the old master node group (the node (1), the node (2), and the node (3)).

FIG. 9 is an illustration of the reference destination information of the configuration information file 31C in the worker node 23 prior to the occurrence of a failure. The reference destination information of the configuration information file 31C indicates the old master node group (the node (1), the node (2), and the node (3)). The reference destination information of the configuration information in the master nodes 21A, 21B, and 21C of the old master node group indicates the old master node group as well.

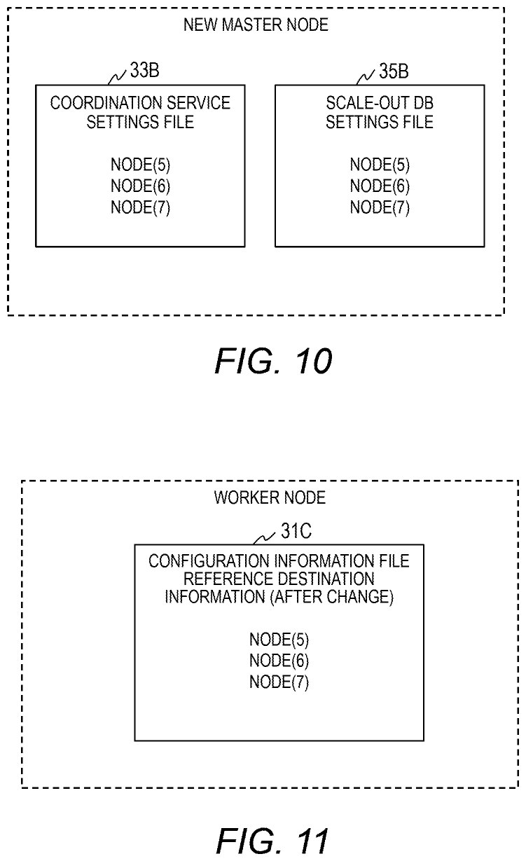

FIG. 10 is an illustration of the coordination service settings file 33B and the scale-out database settings file 35B in each new master node. The coordination service settings file 33B and the scale-out database settings file 35B each indicate the new master node group (a node (4), a node (5), and a node (6)). In this example, the old master nodes are changed to worker nodes as described above, and end their role as master nodes.

Referring back to FIG. 7A, the storage program 211B of each new master node transmits an information synchronization request for building a cluster to the old primary master node (Step S131). The storage program 211A of the old primary master node transmits information held by the coordination service 212A to the new master node that has issued the request, and the coordination service 212B of the new master node keeps the received information (Step S132).

The storage program 211A further transmits information stored in the scale-out database 213A to the new master node that has issued the request, and the scale-out database 213B of the new master node stores the received information (Step S133). When the transmission of required information is completed, the storage program 211A of the old primary master node notifies the completion of response to the new master node that has issued the request (Step S134).

With the information from the old primary master node and the information on the new master nodes, which is held in advance, the new master node group now holds information on all nodes in the cluster. The held information enables the new master node group to properly manage and control the cluster 20.

When the selection of a primary master node in the new master node group precedes the transmission of the information synchronization request (Step S131), the new primary master node may transmit the information synchronization request as a representative to the old primary master node. The new primary master node forwards information received in Steps S132 and S133 from the old primary master node to the new secondary master nodes.

Reference is made to FIG. 7B. Next, the existing nodes change the reference destination information of their own configuration information to “new master node group” (Step S15). For instance, the old primary master node receives information for identifying each node in the new master node group along with the information synchronization request (Step S131), and transmits the information on the new master node group and an instruction to change the reference destination information of the configuration information file to the old secondary master nodes that are in operation and the worker node (Step S151). The old primary master node may receive access destination information on each new master node from the new master node after the transmission of information of the coordination service 212A and the scale-out database 213A is completed.

In the old primary master node and the old secondary master nodes that have received the instruction, the storage program 211A changes the reference destination information in the configuration information file 31A of its own node to the information on the new master node group (Step S152). The storage program 211C of the worker node having received the instruction changes the reference destination information in the configuration information file 31C of its own node to the information on the new master node group (Step S153). After completing the change, the storage program 211C notifies the old primary master node of the completion (Step S154). The storage program 211A of each old secondary master node similarly notifies the old primary master node of the completion.

FIG. 11 is an illustration of the changed reference destination information in the configuration information file 31C of the worker node. The change is made from the pre-change information illustrated in FIG. 9, which indicates the old master node group (the node (1), the node (2), and the node (3)), to information on the new master node group (the node (5), the node (6), and the node (7)). The changed content of the configuration information file 31A in each old master node is the same as the changed information of the configuration information file 31C.

Referring back to FIG. 7B, each node in the old master node group changes the role of its own configuration information file 31A to “worker” (Step S17). Specifically, the storage program 211A of each old master node changes the role of the configuration information file 31A to “worker” (Step S171), and further stops the coordination service 212 and the scale-out database 213 (Steps S172 and S173). Each old master node is then downgraded to operate as a worker node (Step S191).

The processing described above completes an update of the master node group of the cluster. As described above, master authority can be transferred to new master nodes before the coordination services and scale-out databases of old master nodes are stopped, by adding as many new master nodes as the minimum unit. Master node redundancy can thus be restored without shutting down the cluster.

### Second Embodiment

The first embodiment involves changing the old master node group to worker nodes and forming a post-failure master node group from new master nodes alone. In a second embodiment of this invention described below, old master nodes that are in operation (that are normal) are included in the post-failure master node group in addition to newly added master nodes. This can expand master node redundancy. The following description is centered mainly on differences from the first embodiment.

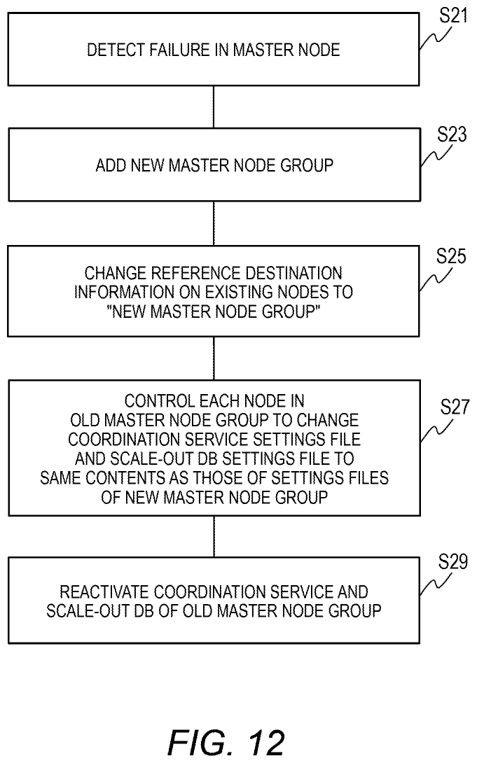

FIG. 12 is a flow chart for illustrating processing to be executed when a failure occurs in one of the master nodes of the cluster 20. When a failure occurs in any one of the master nodes in the cluster 20 (Step S21), a new master node group including three or more master nodes is added to the cluster 20 (Step S23). For example, the system administrator adds to the cluster 20 a new master node group to which required settings are set. The new master nodes are physical master nodes or virtual master nodes.

Each of the added new master nodes hold information on the respective new master nodes in advance. The new master nodes further hold information for identifying each old master node that is in operation. The new master node group can hold communication to and from the old master nodes in the cluster 20, and obtains information held in the coordination service 212 and the scale-out database 213 from the old master node group.

Next, each existing node changes the reference destination information of the configuration information file 31 to the information on the added new master node group (Step S25). Next, the nodes in the old master node group that are in operation each change the coordination service settings file 33 and the scale-out database settings file 35 to the same contents as those of the settings files of the new master node group (Step S27).

Lastly, the nodes in the old master node group that are in operation each reactivate the coordination service 212 and the scale-out database 213 (Step S29). This enables the old master node group to join the post-failure master node group. The post-failure master node group is formed of the added new master node group and a group of old master nodes that are not experiencing a failure.

In response to the joining of the old master node group to the post-failure master node group, the primary master node of the post-failure master node group instructs each node to add information on the old master node group to the reference destination information in the configuration information file. The primary master node and the other nodes each change the configuration information file so that the new master node group and the old master node group are indicated. This completes dynamic addition of a new master node group (redundancy expansion).

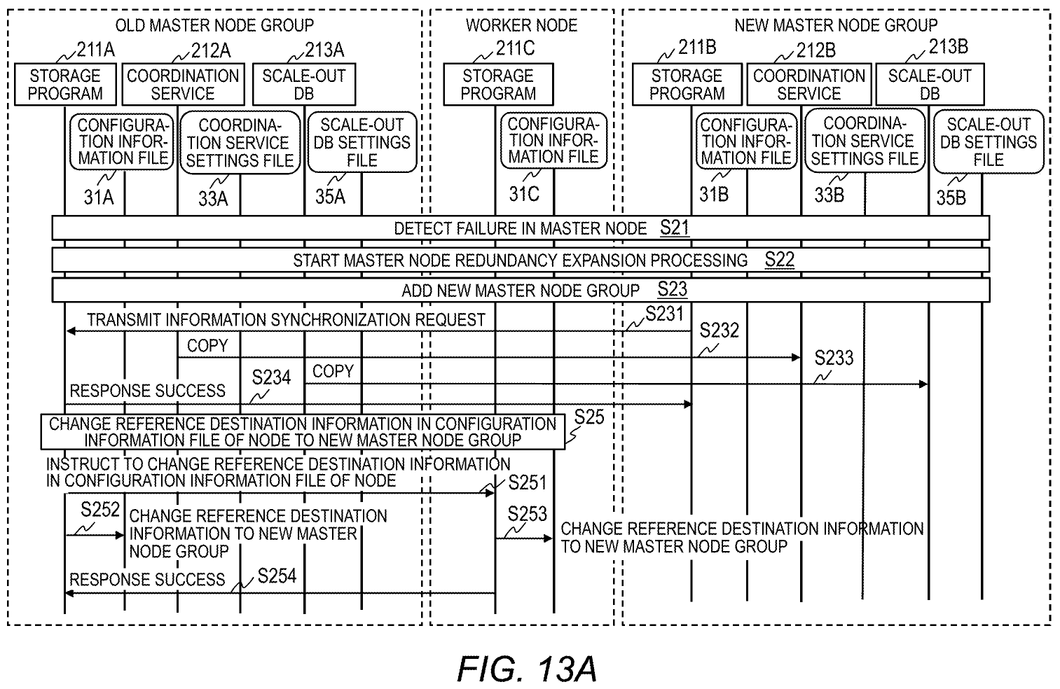

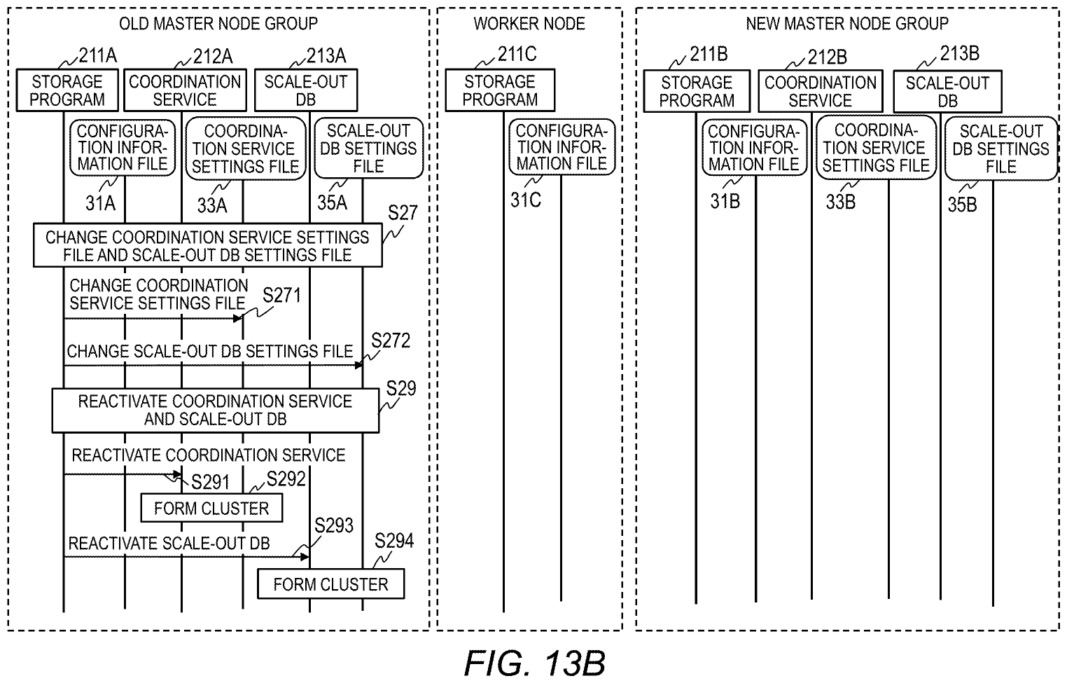

FIG. 13A and FIG. 13B are sequence diagrams for illustrating details of the processing of FIG. 12. Processing illustrated in FIG. 13A is followed by processing illustrated in FIG. 13B. The following description takes as an example a case in which a failure has occurred in the node (1) (the primary master node 21A).

Reference is made to FIG. 13A. Steps S21 and S22 are the same as Steps S11 and S12 in FIG. 7A. As mentioned above, it is assumed here that a failure has occurred in the node (1) (the primary master node 21A). Master node redundancy expansion processing is started (Step S22), and then a new master node group is added to the cluster 20 (Step S23).

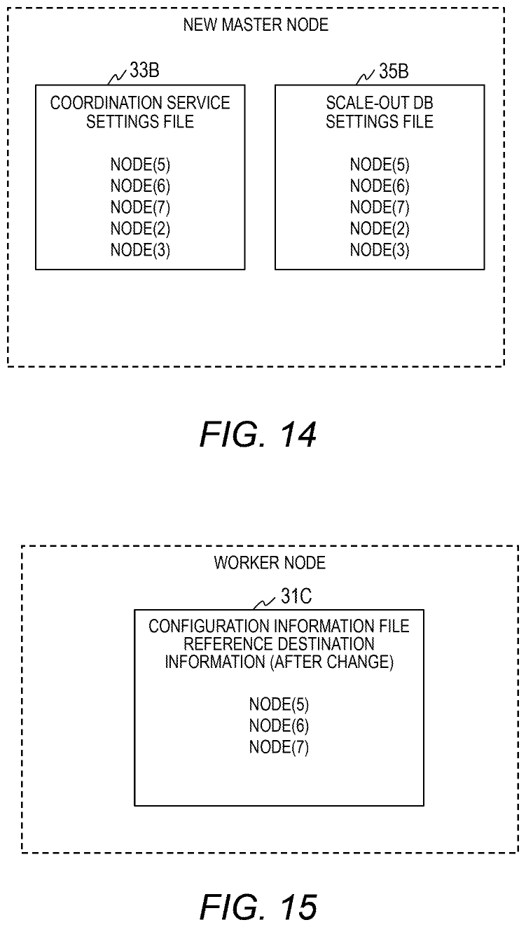

FIG. 14 is an illustration of the coordination service settings file 33B and the scale-out database settings file 35B in each new master node. The coordination service settings file 33B and the scale-out database settings file 35B each indicate the new master node group (a node (4), a node (5), a node (6)) and the group of old master nodes that are in operation (the node (2) and the node (3)). In this example, the old master nodes are also added to the post-failure master node group as described above.

The contents of the coordination service settings file 33A and the scale-out database settings file 35A in each old master node prior to the failure are as illustrated in FIG. 8. The reference destination information of the configuration information file 31C in the worker node 23 prior to the failure is as illustrated in FIG. 9.

Referring back to FIG. 13A, Steps S231 to S234 are the same as Steps S131 to S134 in FIG. 7A. Next, each existing node changes the reference destination information of the configuration information file to the information on the post-failure master node group (Step S25). Specifically, the old primary master node receives information for identifying each node in the new master node group along with the information synchronization request (Step S231), or after Step S234, and transmits the information on the new master node group and an instruction to change the reference destination information of the configuration information file to the old secondary master nodes that are in operation and the worker node (Step S251).

In the old primary master node and the old secondary master nodes that have received the instruction, the storage program 211A changes the reference destination information in the configuration information file 31A of its own node to the information on the new master node group (Step S252). The storage program 211C of the worker node having received the instruction changes the reference destination information in the configuration information file 31C of its own node to the information on the new master node group (Step S253). Step S254 is the same as Step S154 in FIG. 7.

FIG. 15 is an illustration of the changed reference destination information in the configuration information file 31C of the worker node. The change is made from the pre-change information illustrated in FIG. 9, which indicates the old master node group (the node (1), the node (2), and the node (3)), to information on the new master node group (the node (5), the node (6), and the node (7)). The changed content of the configuration information file 31A in each old master node is the same as the changed information of the configuration information file 31C.

Reference is made to FIG. 13B. Next, the old master nodes that are in operation each change the coordination service settings file 33A and the scale-out database settings file 35A to the same contents illustrated in FIG. 14 as those of the settings files 33B and 35B of the new master node group (Step S27).

Specifically, the storage program 211A of the old primary master node instructs the old secondary master nodes to rewrite the coordination service settings file 33A. The storage program 211A of each of the old primary master node and the old secondary master nodes rewrites the coordination service settings file 33A so that information for identifying each new master node and information for identifying each old master node that is in operation are indicated (Step S271).

Further, the storage program 211A of the old primary master node instructs the old secondary master nodes to rewrite the scale-out database settings file 35A. The storage program 211A of each of the old primary master node and the old secondary master nodes rewrites the scale-out database settings file 35A so that information for identifying each new master node and information for identifying each old master node that is in operation are indicated (Step S272).

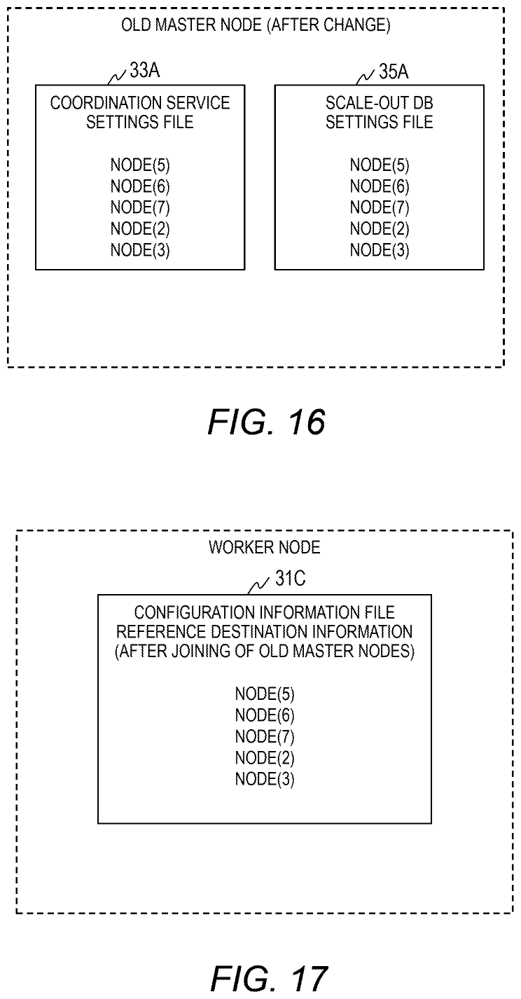

FIG. 16 is an illustration of the changed coordination service settings file 33A and scale-out database settings file 35A in the old master nodes. The settings files 33A and 35A each indicate information on the group of old master nodes that are in operation (the node (2) and the node (3)) and information on the new master node group (the node (5), the node (6), and the node (7)).

Next, the old master nodes that are in operation each reactivate the coordination service 212A and the scale-out database 213A (Step S29). Specifically, the storage program 211A reactivates the coordination service 212A (Step S291). The coordination service 212A forms the cluster together with the coordination services 212A of the other old master nodes and the coordination services 212B of the new master nodes (Step S292).

The storage program 211A further reactivates the scale-out database 213A (Step S293). The scale-out database 213A forms the cluster together with the scale-out databases 213A of the other old master nodes and scale-out databases 213B of the new master nodes (Step S294).

With the reactivation of the coordination service 212A and the scale-out database 213A, the old master nodes join the post-failure master node group. The storage program of the primary master node of the post-failure master node group instructs each node in the cluster 20 to add information on the joined old master node group to the reference destination information of the configuration information file. The storage program of each of the primary master node and the other nodes changes the configuration information file so that the new master node group and the old master node group are indicated.

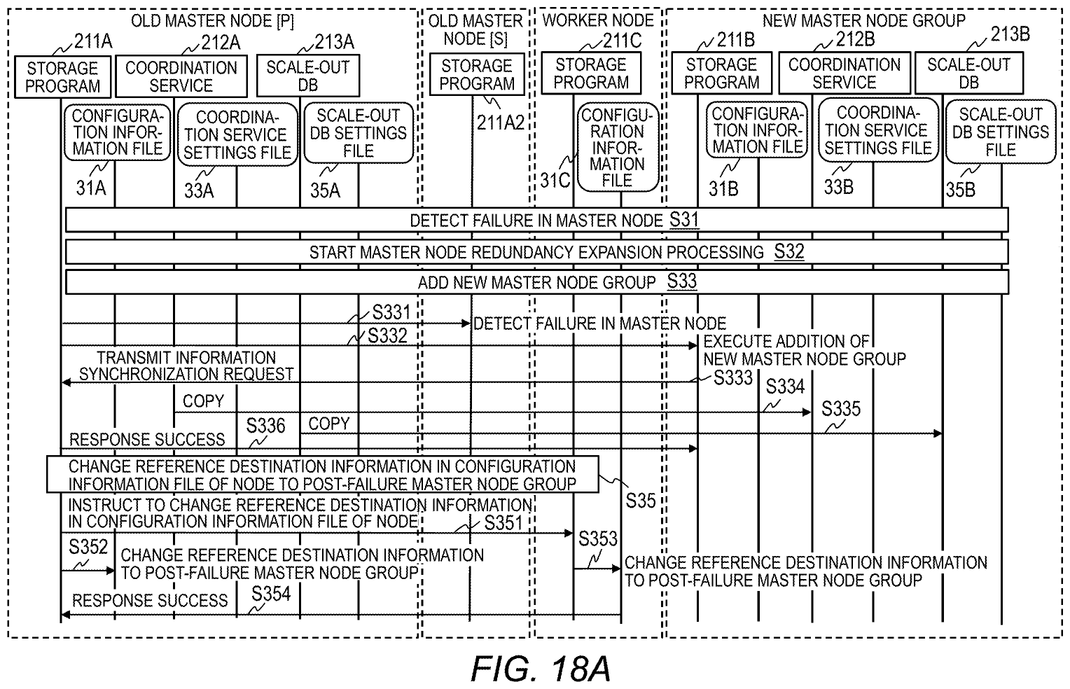

FIG. 17 is an illustration of the reference destination information in the configuration information file 31C of the worker node that has been changed after the joining of the old master nodes. The reference destination information includes information on the old master node group (the node (2) and the node (3)) in addition to information on the new master node group (the node (5), the node (6), and the node (7)).

The processing described above completes an update of the master node group of the cluster. As described above, management of the cluster 20 can be transferred to the new master node group before the coordination services and scale-out databases of old master nodes are reactivated, by adding as many new master nodes as the minimum unit. Further, master node redundancy can not only be restored but also be expanded by adding the reactivated old master node group to the post-failure master node group.

### Third Embodiment

A computer system according to a third embodiment of this invention is described below. In the third embodiment, a cluster automatically detects a failure in a master node and also adds a new master node group without shutting down the system. This accomplishes redundancy expansion as well as redundancy restoration without requiring a user's work. An example in which old master nodes are added to the post-failure master node group as in the second embodiment is described below. However, the method of the third embodiment is applicable also to a case in which old master nodes are turned into worker nodes as in the first embodiment.

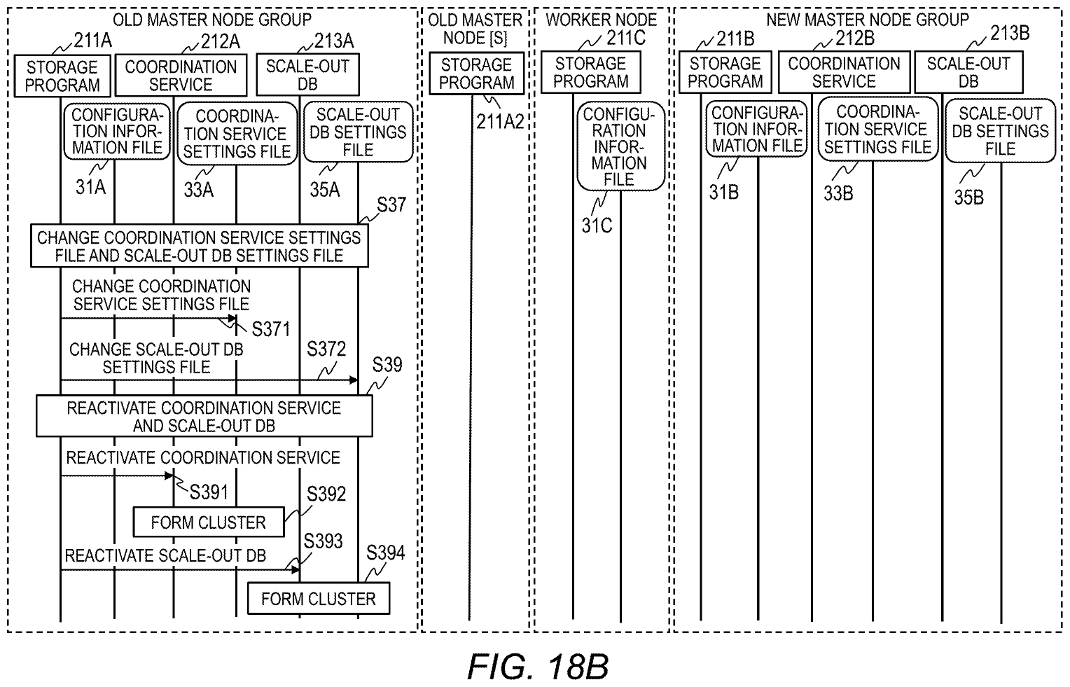

FIG. 18A and FIG. 18B are sequence diagrams for illustrating processing to be executed when a failure occurs in one of secondary master nodes of the cluster 20. Reference is made to FIG. 18A. A failure occurs in one of the secondary master nodes (Step S31), master node redundancy expansion processing is started (Step S32), and a new master node group is added to the cluster 20 (Step S33).

Specifically, the storage program 211A of the old primary master node detects a failure in an old secondary master node from a failure in communication to and from a storage program 211A2 of the old secondary master node (Step S331). The storage program 211A of the old primary master node executes processing of adding a new master node group (Step S332).

For example, the storage program 211A transmits required settings information and an instruction to generate a virtual master node to each physical node in which a template for a virtual master node is stored. Each generated new master node holds the same information as that of the new master nodes described in the second embodiment. A new primary master node is selected from the new master node group.

In FIG. 18A, Steps S333 to S336 are the same as Steps S231 to S234 in FIG. 13A. In FIG. 18A, Step S35 and Steps S351 to S354 are the same as Step S25 and Steps S251 to S254 in FIG. 13A. Reference is made to FIG. 18B. Step S37, Step S371, and Step S372 are the same as Step S27, Step S271, and Step S272 in FIG. 13B. Step S39 and Steps S391 to S394 in FIG. 18B are the same as Step S29 and Steps S291 to S294 in FIG. 13B.

It should be noted that this invention is not limited to the above-described embodiments but include various modifications. For example, the above-described embodiments provide details for the sake of better understanding of this invention; they are not limited to those including all the configurations as described. A part of the configuration of an embodiment may be replaced with a configuration of another embodiment or a configuration of an embodiment may be incorporated to a configuration of another embodiment. A part of the configuration of an embodiment may be added, deleted, or replaced by that of a different configuration.

The above-described configurations, functions, and processing units, for all or a part of them, may be implemented by hardware: for example, by designing an integrated circuit. The above-described configurations and functions may be implemented by software, which means that a processor interprets and executes programs providing the functions. The information of programs, tables, and files to implement the functions may be stored in a storage device such as a memory, a hard disk drive, or an SSD (Solid State Drive), or a storage medium such as an IC card or an SD card.

The drawings show control lines and information lines as considered necessary for explanations but do not show all control lines or information lines in the products. It can be considered that most of all components are actually interconnected.

What is claimed is:

1. A computer system comprising a cluster,
the cluster including a plurality of nodes, which are allowed to hold communication to and from one another over a network, and which are configured to store user data from at least one calculation node,
the plurality of nodes including a plurality of old master nodes,
the plurality of nodes each including reference information, which indicates master nodes of the cluster,
wherein the computer system is configured to add, when a failure occurs in a master node that is one of the plurality of old master nodes, new master nodes to the cluster in a number equal to or larger than a minimum unit number of master nodes, which is determined in advance in order to manage the cluster, and
wherein each old master node that is in operation out of the plurality of old master nodes is configured to rewrite the reference information held in the each old master node so that the new master nodes are indicated.

2. The computer system according to claim 1,
wherein each old master node that is in operation out of the plurality of old master nodes is configured to rewrite the reference information held in the each old master node so that the new master nodes alone are indicated, and
wherein each old master node that is in operation out of the plurality of old master nodes is configured to change into a worker node after the new master nodes are added.

3. The computer system according to claim 1,
wherein each old master node that is in operation out of the plurality of old master nodes is configured to take the role of a master node after the failure, along with the new master nodes, and
wherein each old master node that is in operation out of the plurality of old master nodes is configured to rewrite the reference information held in the each old master node so that the new master nodes and the each old master node that is in operation out of the plurality of old master nodes are indicated.

4. The computer system according to claim 1, wherein the number of the new master nodes matches the minimum unit number.

5. The computer system according to claim 1, wherein the number of the new master nodes matches the number of the plurality of old master nodes.

6. The computer system according to claim 1,
wherein the new master nodes each comprise a virtual node, and
wherein one old master node that is in operation out of the plurality of old master nodes is configured to generate the new master nodes and add the generated new master nodes to the cluster.

7. A method of processing a failure in a master node in a cluster,
the cluster including a plurality of nodes, which are allowed to hold communication to and from one another over a network, and are configured to store user data,
the plurality of nodes including a plurality of old master nodes,
the plurality of nodes each including reference information, which indicates master nodes of the cluster,
the method comprising:
adding, when a failure occurs in a master node that is one of the plurality of old master nodes, new master nodes to the cluster in a number equal to or larger than a minimum unit number of master nodes, which is determined in advance in order to manage the cluster; and
rewriting, by each old master node that is in operation out of the plurality of old master nodes, the reference information held in the each old master node so that the new master nodes are indicated.
